(19) United States
(12) Patent Application Publication
(10) Pub. No.: US 2013/0005309 A1
(43) Pub. Date: Jan. 3, 2013

(54) Method and System for Indicating Telephone Availability

(76) Inventor: Kimani Clark, N. Bethesda, MD (US)

(21) Appl. No.: 13/175,646

(22) Filed: Jul. 1, 2011

(51) Int. Cl. H04M 1/64; H04W 4/16; H04M 1/56

(52) U.S. Cl. 455/414.1; 379/142.17; 379/88.12

(57) ABSTRACT

A telephone system is provided which allows a user to indicate their availability to receive phone calls and allows users to determine which other users are available to receive phone calls. The system allows for connection of phone calls between available parties, thereby eliminating unnecessary missed telephone calls and leaving and/or listening to repeated voicemails for the user. The system removes the uncertainty of whether a telephone call recipient is available eliminating frustration and wasted time for the caller. In one implementation, the system comprises an application or button installed on a telephone which may be activated to indicate to other users that the first user is available to receive and answer telephone calls.

This generally relates to telephony and phone calling between parties. More specifically, it relates to methods and systems to avoid the repeated missing of telephone calls and/or recording of voicemails between two or more parties attempting to reach each other by telephone.

### BACKGROUND

The practice of telephony, the general use of equipment to provide voice communication over a distance, specifically by connecting telephones to each other, has evolved such that in modern times, a telephone may record and report missed telephone calls to its user, and users may leave voicemails, recorded messages that may be listened to by their recipient at a later time. Additionally, the advent of portable telephones such as mobile phones has simultaneously increased the use of telephones to conduct time sensitive conversations as well as the likelihood of missed telephone calls. “Phone tag,” the situation wherein two or more users repeatedly miss each other's telephone calls and/or leave multiple voicemails may be frustrating, particularly when the reason for the repeated calls is time sensitive. Additionally, phone tag causes both parties to waste time making fruitless telephone calls and leaving and/or listening to multiple voicemail messages before finally connecting in a live telephone conversation.

Conventional online chatting platforms often contain a functionality which alerts other platform users when a given platform user is available to “chat,” or exchange written online messages. For example, the Gmail email server from Google (www.gmail.com) contains a “Gchat” functionality which alerts a Gmail user when their Gmail contacts are available to chat. When Gmail User 1, a Gmail contact of Gmail User 2, is signed into Gmail and has enabled the Gchat function, a green circle icon appears next to Gmail User 1's name in Gmail User 2's contact list, indicating that Gmail User 1 is available to chat. If Gmail User 1 is signed onto the Gmail server but idle for a certain time period, this icon turns orange, indicating that Gmail User 1 may be away from their computer and thus unavailable to chat. Additionally, Gmail User 1 may disable the chat function, which turns the icon red when they are signed onto the Gmail server, indicating that they will not receive chat messages. Finally, Gmail User 1 may simply sign out of Gchat while remaining logged onto the Gmail server, which causes Gmail to display the icon in gray to Gmail User 2, indicating that Gmail User 1 is not signed onto the Gmail server. However, this functionality does not permit users to talk on the phone.

Conventional online chatting platforms have been extended to function on mobile telephones. Google Talk is an offshoot of Gchat embracing similar functionality. Google Talk applications exist for many modern “smart phones,” including the Blackberry by Research in Motion and the Droid by Motorola. Using Google Talk, a user may hold real time written conversations outside of their home or office using a cellular telephone. However, this functionality requires that both users have a cellular telephone that supports a Google Talk application, a Google Talk account, and high bandwidth such as that available over a third generation or “3G” cellular telephone network. Additionally, typing on such devices occurs on small, hard to manipulate key pads and can be time consuming and inaccurate. This functionality also does not permit users to talk on the phone.

Conventional users of telephones often experience problems with phone tag. Accordingly, there is a desire to avoid these and other related problems.

### SUMMARY

In accordance with the methods and systems consistent with the present invention, a method in a phone for connecting a phone call is provided, comprising receiving, on the phone, an indication of availability from a first user to answer the phone call. The method further comprises displaying, on the phone, an indication that the first user is available to answer the phone call to a second user based on the indicated availability of the first user.

In one implementation, a method in a phone for connecting a phone call, is provided comprising sending an indication of availability of a first user to answer a phone call to the phone of a second user, and receiving the phone call from the second user in response to the sending of the indication of availability of the first user.

In another implementation, a phone is provided comprising a processor configured to receive an indication of availability to answer a phone call from a first user. The phone further comprises a display configured to display an indication that the first user is available to answer the phone call to a second user based on the indicated availability of the first user.

### BRIEF DESCRIPTION OF THE DRAWINGS

FIG. 1 depicts an anterior view of a telephone displaying a phone application implementation consistent with the present invention.

FIG. 2 depicts an anterior view of a telephone with a hardware availability button in accordance with the present invention.

FIG. 3 depicts an anterior view of a telephone displaying an implementation in accordance with voicemail.

FIG. 4 depicts an anterior view of a telephone displaying an implementation in accordance with a contact list.

FIG. 5 illustrates steps in a method for connecting a call between two available telephone users, at least one of whom has left the other a voicemail.

FIG. 6 illustrates steps in a method for connecting a call between two available telephone users with a contact list.

### DETAILED DESCRIPTION

Methods and systems in accordance with the present invention provide a software application, switch or button, whereby telephone users may indicate to other telephone users that they are currently ready and available to answer a phone call at a given moment in time. These methods and systems permit an available user to quickly and easily see that another user is available and connect a telephone call with the available user, thereby avoiding phone tag. This call may be connected automatically, simply by one user selecting the other user, or in one implementation, the call is initiated and the available call recipient is selected and connected by the system automatically.

In one implementation, a user may see who, among callers that have left them a voicemail, is currently available to be called, thus allowing the user to return the call and connect to the caller personally and avoid a game of phone tag. In another implementation, users may see who, among their entire contact list or other telephone “address book,” is available to be called at the moment, thus allowing the user to avoid the first step in a game of phone tag and connect to the desired recipient personally on the first attempt.

These methods and systems may be implemented on hardwired, home telephones or on mobile telephones such as cellular telephones. They may also be implemented on any suitable mobile communication device including smartphones, PDA's and walkie-talkies. They may be implemented into the phone in any way, for example a software application may be preloaded onto the telephone at the time of purchase, or they may be downloaded onto the telephones as an application or widget. They may also be implemented with a button, switch, voice activation or any other suitable method on the phone that indicates a user is currently available to talk.

By various implementations of methods and systems consistent with the present invention, users will realize time savings and avoid the aggravation of phone tag. Users may make telephone calls with confidence that they will connect personally with the desired recipient on the first attempt. Additionally, users will avoid wasting time making fruitless, unanswered telephone calls and/or leaving and/or listening to voicemails.

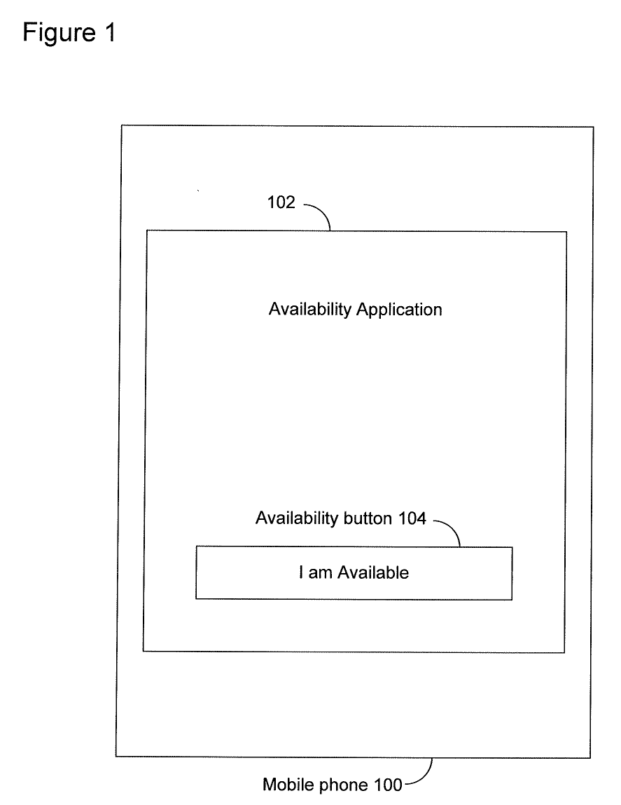

FIG. 1 depicts an anterior view of a telephone displaying an exemplary embodiment of an application in accordance with methods and systems consistent with the present invention. Mobile phone 100 contains screen, which, in this screen view, displays one implementation consistent with the present invention. In this implementation, the user has opened the availability application 102, which displays availability button 104, which, when clicked, turns on the user's availability indicator. The availability indicator may be used by the user when he or she is actually available to talk (as opposed to just the phone being on). After the user has clicked availability button 104, an icon or other indicator will be displayed to other application users on their phones, indicating that the user is available to receive phone calls. In one implementation, the user may optionally exclude selected people from their contact list from seeing their availability. The availability application 102 may be a cellular or smart phone application such as an iPhone application. It may also be implemented as hardware, software or a combination of hardware and software. Mobile phone 100 may be any type of communication device such as a cellular phone, smart phone, PDA, cellular phone, walkie-talkie or any other mobile or non-mobile communication device.

The system may be implemented with one or more central servers communicating directly or indirectly with the phones. These communications may take place, for example, over cellular networks. The indications of a user's availability may be sent from a phone to the server(s), stored and sent to other users to indicate the availability of the first user. The phones may store a software application in memory having instructions executable by a processor on the phone to implement methods and systems in accordance with the present invention.

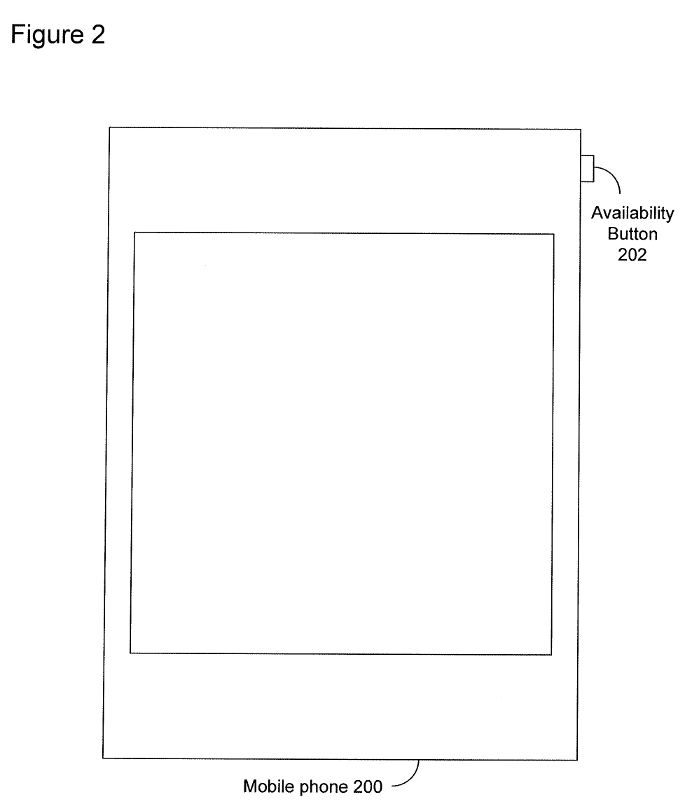

FIG. 2 depicts an anterior view of a telephone displaying an exemplary embodiment of the present invention. Mobile phone 200 contains hardware availability button 202. When the user of mobile phone 200 depresses button 202, the user's availability is activated and the availability indicator for the user of mobile phone 200 becomes visible to other application users. In one implementation, button 202 may be a switch. In other implementations, Button 202 may be located anywhere on or in mobile phone 200.

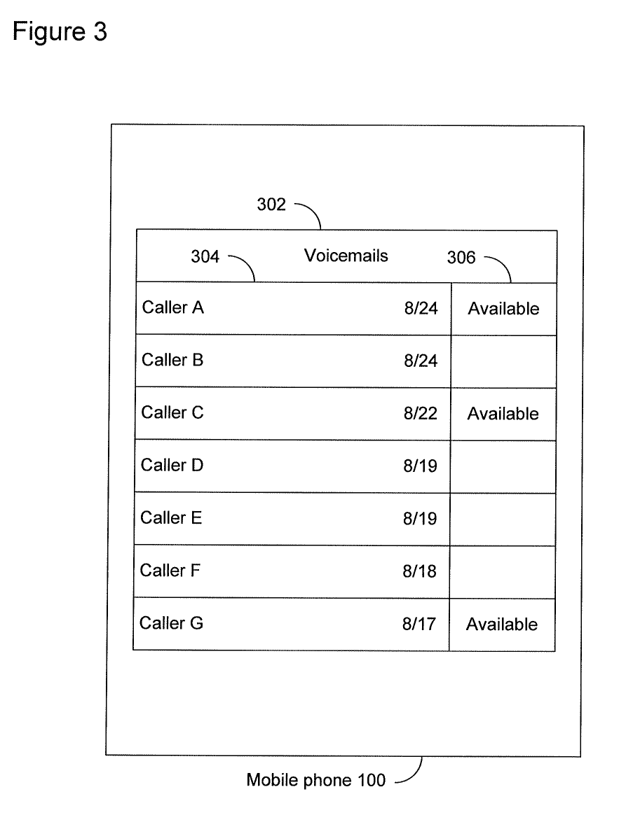

FIG. 3 depicts an anterior view of a telephone displaying an exemplary embodiment of an application in accordance with methods and systems consistent with the present invention. Mobile phone 100 contains screen, which, in this screen view, displays a list of voicemails in the user's voicemail box 302. Column 304 contains a list of callers who have left voicemails for the user. In one implementation, column 304 contains other descriptors of the voicemail message, such as the date and/or time when the voicemail was recorded. Column 306 contains an indication of which of these callers have activated the availability application button 104, switch or hardware button 202 and are currently available to answer a telephone call. Availability may be indicated by the word “Available” in Column 306, corresponding to the available caller. In other implementations, this indicator may be represented by any other appropriate word, icon, or indicator. When the user clicks an available caller's name and/or information in column 304, the availability application 102 will attempt to connect a telephone call between the two users. Alternatively, the availability application 102 may call back the first available caller upon activation of the availability button 104. Also the user may select users that are available in their contact list of phone book on their mobile phone 100.

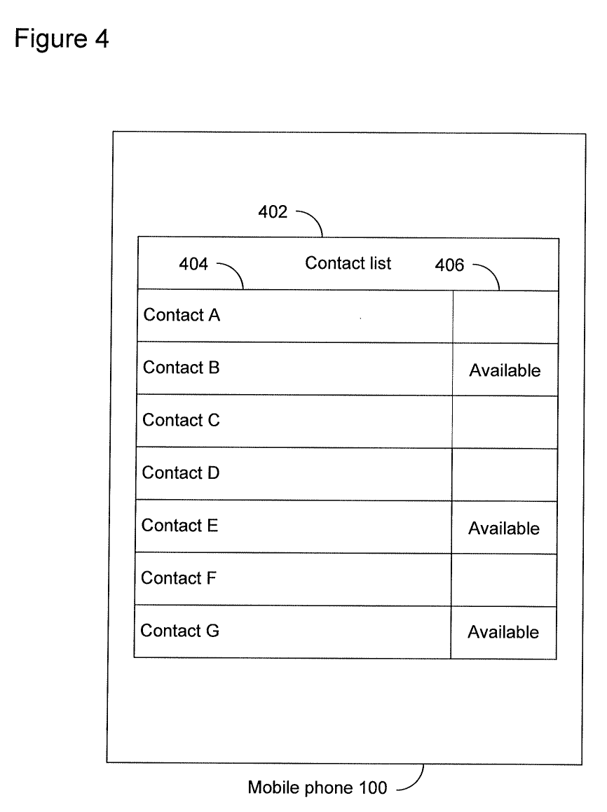

FIG. 4 depicts an anterior view of a telephone displaying an exemplary embodiment of an application in accordance with methods and systems consistent with the present invention. In this implementation, a contact list 402 is shown on mobile phone 100 displaying a list of the contacts in the user's cellular phone. Column 404 contains a list of contacts, and in one implementation, column 406 contains an indication of which of these contacts have activated the availability application button 104, switch or hardware button 202 and are currently available to answer a telephone call. Availability may be indicated by the word “Available” in Column 406, corresponding to the available contact. In other implementations, this indicator may be represented by any other appropriate word, icon, or indicator. When the user clicks an available contact's name in column 404, the availability application 102 will attempt to connect a telephone call between the two users.

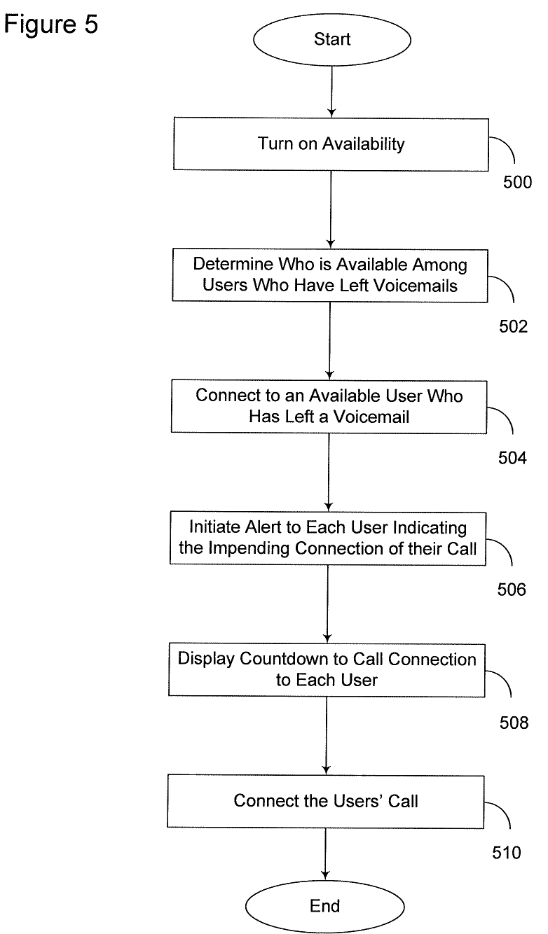

FIG. 5 illustrates steps in an exemplary implementation of methods and systems consistent with the present invention. First, the user performs whatever action the implementation requires to cause the availability application 102 to indicate that the user is available to receive a call (step 500). In one implementation, “Available” may be the default option, and the availability application 102 will display that the user is available whenever the user's phone is on, unless the user takes some action to change their status to indicate that they are not available. In other implementations, the user may push a button 202 located anywhere on their telephone turning on availability, or it may require the user to open the availability application 102 within their telephone menu and select the availability button 104 from within the application. The availability indication may also be voice activated. Next, the user views a list of callers who have left them voicemails to determine which of them is available to receive a call (step 502). The user may select any of the callers indicated as available by the availability application 102, and the application will connect a telephone call between the user and the caller (step 504). In one implementation, this does not require that the first user have their availability indicator turned on. After the user elects to call another party in step 504, each of the two parties' telephones will display an alert message indicating that their call will be connected shortly (step 506). In one implementation, this message may include an exact time until the call is connected (e.g., 5 seconds), while in other implementations it may not indicate a time. Next, the alert message of step 506 will become an active countdown, toggling through the number of seconds remaining until it reaches zero seconds remaining and the call is connected (step 508). In another implementation, no countdown is displayed. Finally, the call between the two parties is connected (step 510). In one implementation, connection of a telephone call involving an available party causes the availability application 102 to automatically turn off the party's available indicator, instead indicating that the party is unavailable until the termination of the telephone call.

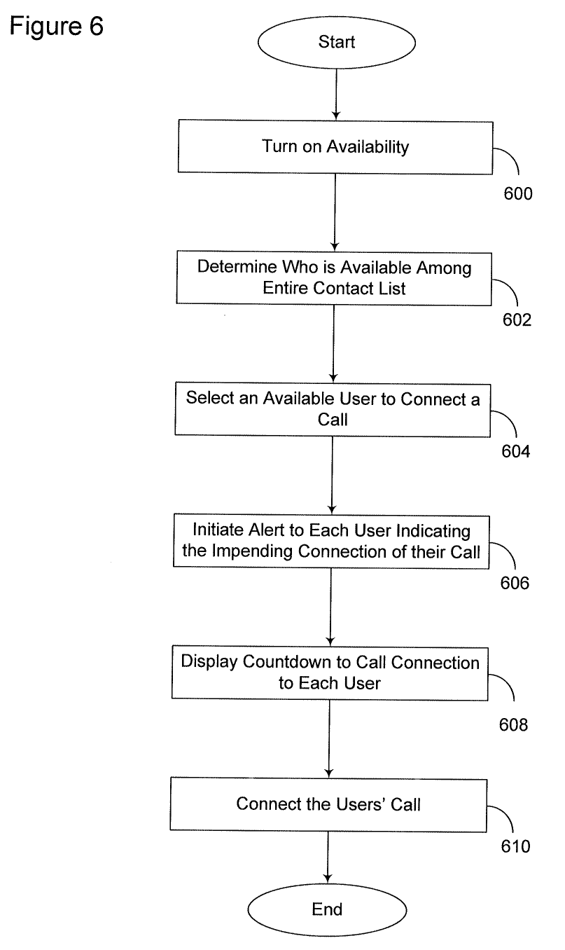

FIG. 6 illustrates steps in an exemplary implementation of methods and systems consistent with the present invention. First, the user performs whatever action the implementation requires to cause the availability application 102 to indicate that the user is available to receive a call (step 600). In one implementation, “Available” may be the default option, and the availability application 102 will display that the user is available unless the user takes some action to change their status to indicate that they are not available. In other implementations, turning on availability may require the user to simply push a button or switch located anywhere on their telephone, or it may require the user to open the availability application 102 within their telephone menu and select available 104 from within the application. Next, the user views their contact list or other telephone “address book” to determine who is available to receive a call (step 602). The user may select any of the callers that the availability application 102 indicates as available, and the application will connect a telephone call between the user and the caller (step 604). In one implementation, this does not require that the first user have the availability indicator turned on. After the user elects to call another party in step 604, each of the two parties' telephones will display an alert message indicating that their call will be connected shortly (step 606). In one implementation, this message may include an exact time (e.g., 5 seconds) until the call is connected, while in other implementations it may not indicate a time. Next, the alert message of step 606 will become an active countdown, toggling through the number of seconds remaining until it reaches zero seconds remaining and the call is connected (step 608). In another implementation, no countdown is displayed. Finally, the call between the two parties is connected (step 610). In one implementation, connection of a telephone call involving an available party causes the availability application 102 to automatically turn off the party's available indicator, instead indicating that the party is unavailable until the termination of the telephone call.

The foregoing description of various embodiments provides illustration and description, but is not intended to be exhaustive or to limit the invention to the precise form disclosed. Modifications and variations are possible in light of the above teachings or may be acquired from practice in accordance with the present invention. It is to be understood that the invention is intended to cover various modifications and equivalent arrangements included within the spirit and scope of the appended claims.

1. A method in a phone for connecting a phone call, comprising:
receiving, on the phone, an indication of availability from a first user to answer the phone call, wherein the indication of availability is indicated by activation of an interface by the first user; and
displaying, on the phone, an indication that the first user is available to answer the phone call to a second user based on the indicated availability of the first user.

2. The method of claim 1, further comprising initiating the phone call between the first user and second user based on the received indication of availability of the first user.

3. The method of claim 2, further comprising automatically connecting the phone call between the first user and second user based on the received indication of availability of the first user.

4. The method of claim 1, further comprising:
receiving indications that a plurality of other users are available to answer the phone call; and
displaying the indications of the availability of the plurality of other users who are available to answer the phone call.

5. The method of claim 1, wherein the first user has left a voicemail for the second user, and further comprising receiving the indication of availability of the first user associated with the voicemail left by the first user.

6. The method of claim 1, further comprising:
receiving one or more indications of availability to answer a phone call of one or more users who have left a voicemail for the second user;
selecting one of the indicated users from the list of voicemails; and
initiating a call between the second user and the selected user.

7. The method of claim 6, further comprising automatically initiating a call between the second user and the first available user in the list of voicemails.

8. The method of claim 1, wherein the first user's phone number is a contact in the phone of the second user, and further comprising receiving the indication of availability of the first user associated with the contact information of the first user.

9. The method of claim 1, further comprising:
receiving one or more indications of availability to answer a phone call of one or more users whose phone numbers are contacts in the phone of the second user;
selecting one of the indicated users from the list of contacts; and
initiating a call between the second user and the selected user.

10. The method of claim 1, wherein the phone is a mobile communication device.

11. The method of claim 10, wherein the phone is a cellular phone.

12. The method of claim 1, wherein the phone is a landline phone.

13. The method of claim of claim 1, wherein the phone comprises a software application downloadable to the phone over a cellular network for implementing the receiving of the indication of availability and the displaying of the indication that the first user is available.

14. A method in a phone for connecting a phone call, comprising:
sending an indication of availability of a first user to answer a phone call to the phone of a second user by activating an interface by the first user; and
receiving the phone call from the second user in response to the sending of the indication of availability of the first user.

15. A phone, comprising:
a processor configured to receive an indication of availability to answer a phone call from a first user, wherein the indication of availability is indicated by activation of an interface by the first user; and
a display configured to display an indication that the first user is available to answer the phone call to a second user based on the indicated availability of the first user.

16. The phone of claim 15, further comprising:
a second interface with a button configured to indicate availability to answer a second phone call to another user.

17. The phone of claim 16, wherein the second interface is one of: (1) a virtual button a display, (2) a button, and (3) a switch.

18. The phone of claim 15, further comprising a software application comprising executable instructions to receive an indication of availability to answer the phone call from the first user; and wherein the processor executes the executable instructions of the software application.

19. The phone of claim 15, wherein the processor is further configured to initiate the phone call between the first user and second user based on the received indication of availability of the first user.

20. The phone of claim 19, wherein the processor is further configured to automatically connect the phone call between the first user and second user based on the received indication of availability of the first user.

21. The phone of claim 15, wherein the processor is further configured to:
receive indications that a plurality of other users are available to answer the phone call; and
the display is further configured to display the indications of the availability of the plurality of other users who are available to answer the phone call.

22. The phone of claim 15, wherein the first user has left a voicemail for the second user, and wherein the processor is further configured to receive the indication of availability of the first user associated with the voicemail left by the first user.

23. The phone of claim 5; wherein the processor is further configured to:
receive one or more indications of availability to answer a phone call of one or more users who have left a voicemail for the second user;
select one of the indicated users from the list of voicemails; and
initiate a call between the second user and the selected user.

24. The phone of claim 15, wherein the first user's phone number is a contact in the phone of the second user, and wherein the processor is further configured to receive the indication of availability of the first user associated with the contact information of the first user.

25. The phone of claim 15, wherein the processor is further configured to:
receive one or more indications of availability to answer a phone call of one or more users whose phone numbers are contacts in the phone of the second user;
select one of the indicated users from the list of contacts; and
initiate a call between the second user and the selected user.

26. The phone of claim 15, wherein the phone comprises a software application downloadable to the phone over a cellular network for implementing the receiving of the indication of availability and the displaying of the indication that the first user is available.
